(19) United States
(12) Patent Application Publication
(10) Pub. No.: US 2014/0324725 A1
(43) Pub. Date: Oct. 30, 2014

(54) DELIVERY OF GOODS TO DYNAMICALLY-LOCATED USERS

(71) Applicants: K. Andrew Edmonds, San Jose, CA (US); David Ramadge, Mountain View, CA (US); Andrew David Palmer, Campbell, CA (US); Ilya Brown, San Francisco, CA (US); Kartik Rao, Santa Clara, CA (US); Jack Phillip Abraham, Palo Alto, CA (US)

(72) Inventors: K. Andrew Edmonds, San Jose, CA (US); David Ramadge, Mountain View, CA (US); Andrew David Palmer, Campbell, CA (US); Ilya Brown, San Francisco, CA (US); Kartik Rao, Santa Clara, CA (US); Jack Phillip Abraham, Palo Alto, CA (US)

(73) Assignee: EBAY INC., SAN JOSE, CA (US)

(21) Appl. No.: 14/142,464

(22) Filed: Dec. 27, 2013

Related U.S. Application Data
(60) Provisional application No. 61/815,673, filed on Apr. 24, 2013.

(51) Int. Cl. G06Q 10/08; G06Q 30/06

(52) U.S. Cl. CPC G06Q 10/0835; G06Q 30/0635; G06Q 10/0833
USPC 705/333

(57) ABSTRACT

In an example embodiment, location information is received from a plurality of mobile devices operated by on-duty valets. An online order for local delivery of an item to a consumer is received. A current location of the consumer is determined. A store having a least transit time from the current location of the consumer that has the item in stock is determined. Then, a valet having a least transit time to the determined store is determined. A job may be assigned to the valet having the least transit time to the determined store.

### PRIORITY

This application is a Non-Provisional of and claims the benefit of priority under 35 U.S.C. §119(e) from U.S. Provisional Application Ser. No. 61/815,673, entitled “DELIVERY OF GOODS TO DYNAMICALLY-LOCATED USERS,” filed on Apr. 24, 2013 which is hereby incorporated by reference herein in its entirety.

### TECHNICAL FIELD

This application relates generally to data processing. More specifically, this application relates to the delivery of goods to dynamically-located users.

### BACKGROUND

With the rise of mobile computing, specifically smartphones and tablets, there has been an increase in interest in new ways to shop using these new devices and their various capabilities. Fast delivery is important to many consumers, and some businesses have begun to offer same day delivery. One problem, however, is that users are increasingly on the go, and one big impediment to quick delivery is that users may not be home during the time when a delivery could be scheduled.

### BRIEF DESCRIPTION OF THE DRAWINGS

The present disclosure is illustrated by way of example, and not by way of limitation, in the figures of the accompanying drawings in which:

FIG. 1 is a network diagram depicting a client-server system, within which one example embodiment may be deployed.

FIG. 2 is a block diagram illustrating marketplace and payment applications that, in one example embodiment, are provided as part of the networked system.

FIGS. 3A-3C are flow diagrams illustrating a method of launching an application and signing in, in accordance with an example embodiment.

FIGS. 4A-4B are flow diagrams illustrating a method of filling a shopping cart and ordering flow in accordance with an example embodiment.

FIGS. 5A-5C are flow diagrams illustrating a method of checking out in accordance with an example embodiment.

FIGS. 6A-6D are flow diagrams illustrating a method of delivering an order in accordance with an example embodiment.

FIGS. 7A-7B are flow diagrams illustrating a method of executing a home flow, such as home flow of FIG. 3 in more detail, in accordance with an example embodiment.

FIGS. 8A-8C are flow diagrams illustrating a method of determining and presenting search results, such as search results of FIG. 7, in more detail, in accordance with an example embodiment.

FIG. 9 depicts screen captures in accordance with an example embodiment.

FIG. 10 depicts further screen captures in accordance with an example embodiment.

FIG. 11 depicts further screen captures in accordance with an example embodiment.

FIG. 12 depicts a further screen capture in accordance with an example embodiment.

FIG. 13 depicts further screen captures in accordance with an example embodiment.

FIG. 14 depicts further screen captures in accordance with an example embodiment.

FIG. 15 depicts further screen captures in accordance with an example embodiment.

FIG. 16 depicts a further screen capture in accordance with an example embodiment.

FIG. 17 is a screen capture depicting a sign-in screen in accordance with an example embodiment.

FIG. 18 is a screen capture depicting a screen where the valet may indicate he or she is on duty (or not).

FIG. 19 is a screen capture depicting a screen where the valet may receive a new order.

FIG. 20 is a screen capture depicting a screen where the valet may view additional order detail.

FIG. 21 is a screen capture depicting a screen once the valet has accepted the order.

FIG. 22 is a screen capture depicting a screen that allows the valet to confirm that the item has been picked up.

FIG. 23 is a flow diagram illustrating a method in accordance with an example embodiment.

FIG. 24 is a block diagram illustrating a mobile device, according to an example embodiment.

FIG. 25 is a block diagram of a machine in the form of a computer system within which a set of instructions may be executed for causing the machine to perform any one or more of the methodologies discussed herein.

### DETAILED DESCRIPTION

The description that follows includes illustrative systems, methods, techniques, instruction sequences, and machine-readable media (e.g., computing machine program products) that embody illustrative embodiments. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

In an example embodiment, a service is provided that allows consumers to shop using electronic devices such as computers and smartphones, but have purchases fulfilled by local merchants. In another example embodiment, same-day delivery of purchases is provided by utilizing a courier service, where a courier will physically retrieve appropriate products from local merchants and deliver the items to the customer.

Specifically, in some embodiments, a consumer may purchase an item while located at a first location, and yet the delivery of the item, even if only a few hours later, comes when the user has moved from the first location to a second location (e.g., with the user being in motion beyond the second location toward a third location). Example embodiments are herein described covering cases where a system is able to handle such use cases.

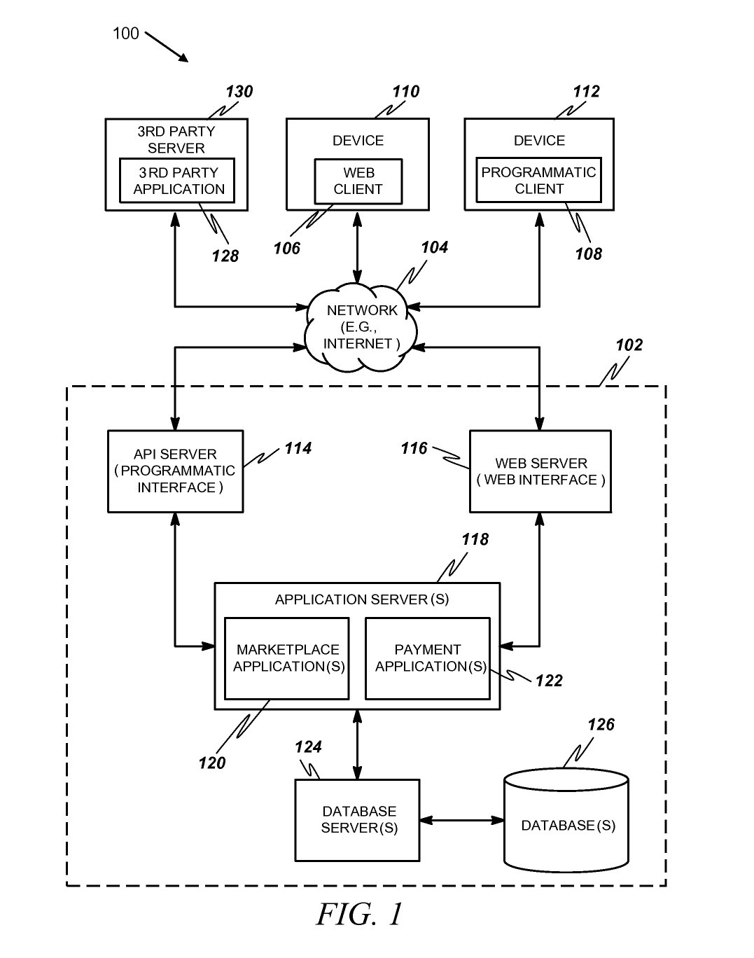

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a wide area network (WAN)) to one or more clients. FIG. 1 illustrates, for example, a web client 106 (e.g., a browser, such as the Internet Explorer browser developed by Microsoft Corporation of Redmond, Washington State) and a programmatic client 108 executing on respective devices 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course, not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, California) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

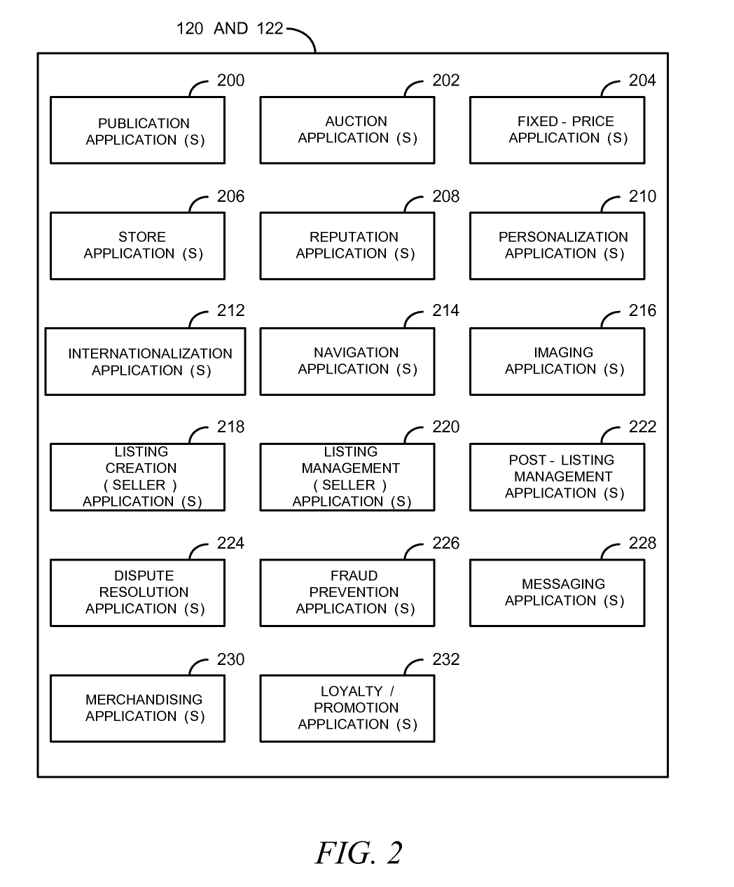

FIG. 2 is a block diagram illustrating marketplace and payment applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions, etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), short message service (SMS), text, facsimile, or voice (e.g., voice over IP (VoIP)) messages via the wired (e.g., the Internet), plain old telephone service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

As described above, in an example embodiment, a system where users can purchase items online and have the items available for pickup at or delivery from a local store is provided. An app may be installed on a user device, such as a smartphone or tablet computer. This app may provide the user various screens allowing the user to purchase an item and establish delivery of the item to the user's location. This app may interface with a server that may then send valet requests to a number of possible valets to deliver the item. The server can then coordinate which valet to deliver the item. GPS information from the user device can be utilized in determining which valet to deliver the item, and this information can also then be relayed to the valet selected so that delivery may occur. In an example embodiment, GPS information from the user device is updated periodically and sent to the selected valet, allowing the selected valet to, for example, alter his or her route based on a change in the location of the user.

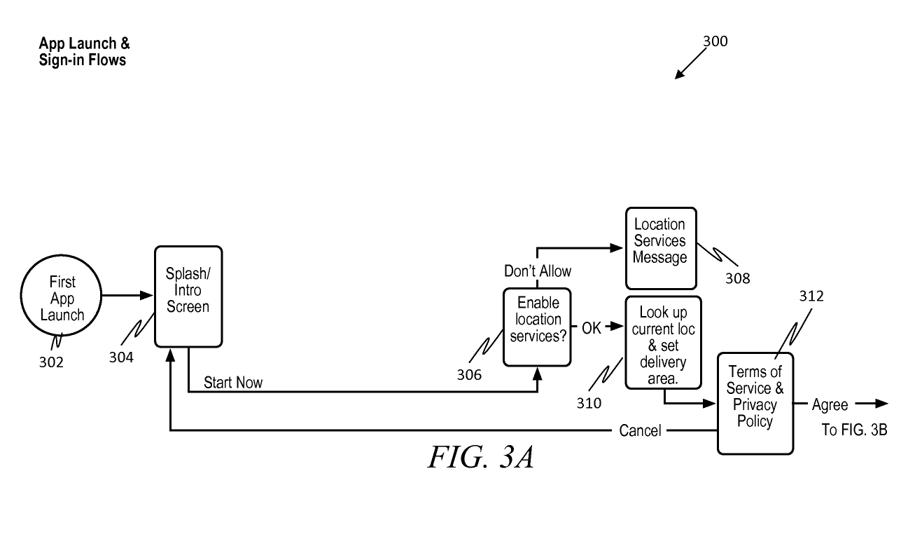

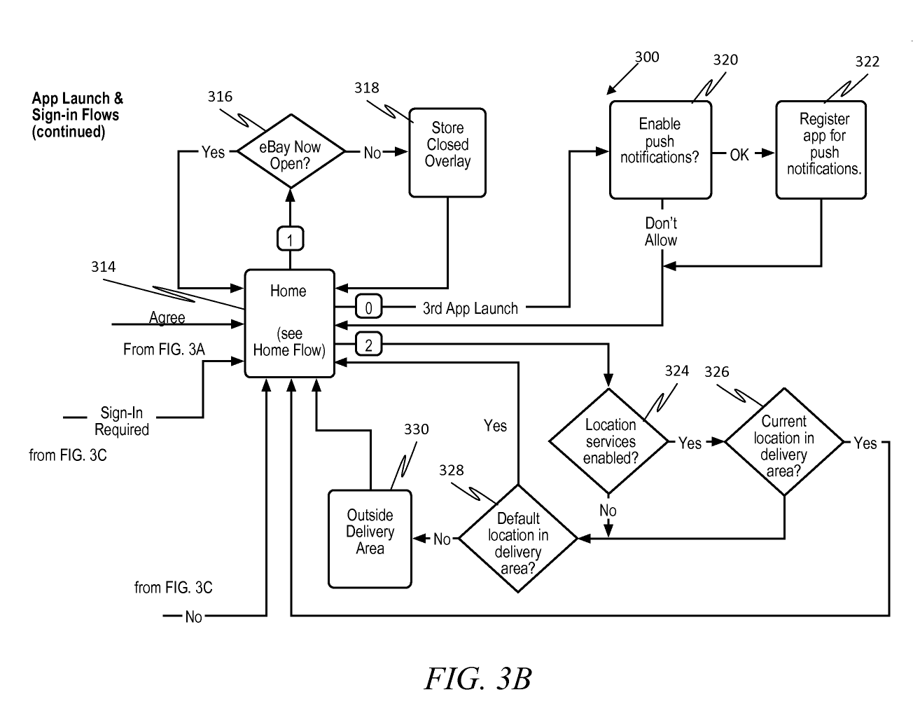

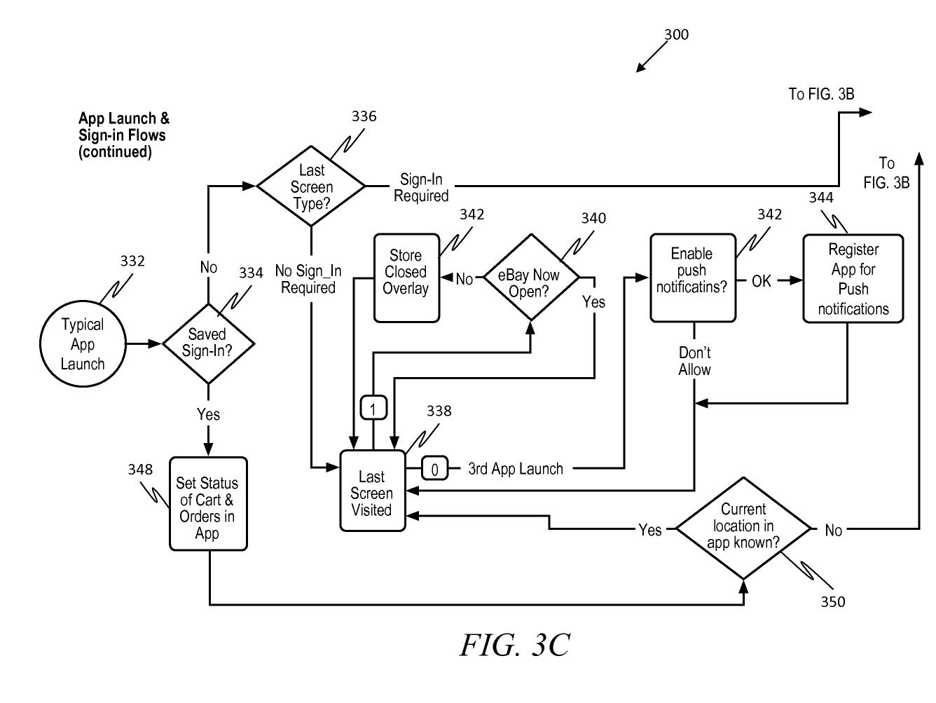

FIGS. 3A-9B provide example flow diagrams depicting transitions between various states of a user interface provided to allow the user to engage with such a system. FIGS. 3A-3C are flow diagrams illustrating a method 300 of launching an application and signing in, in accordance with an example embodiment. At the first application launch 302, a splash/intro screen may be presented 304. Then, at 306, it may be determined if location services have been enabled/allowed. If not, then a location services message 308 may be displayed. Otherwise, at 310 the system may look up the current location and set delivery area based on that location. Then, at 312, a terms of service and privacy policy message may be displayed. The user can agree or disagree with the policy. Disagreeing sends the flow back to 304. Agreeing sends the flow to 314 of FIG. 3B, which is a home flow, and which will be described in more detail later.

From the home flow 314, at 316 it may be determined if a daily delivery service, such as eBay Now, is open. If so, the home flow 314 may continue. If not, then at 318 a store closed overlay may be placed over the home flow 314.

Also from the home flow 314, upon the third launch of the application, at 320 it may be determined if push notifications have been enabled. If so, then at 322 the application may be registered for push notifications. Otherwise, push notifications are not allowed.

Additionally, from the home flow 314, at 324 it may be determined if location services have been enabled. If so, then at 326 it may be determined if the current location is in the delivery area. If not, or if location services were not enabled, then a default location is used and at 328 it is determined if the default location is in the delivery area. If not, then at 330 an indication that the user is outside the delivery area may be used.

Turning to FIG. 3C, upon a typical application launch 332, it may be determined at 334 if there is a saved sign in. If not, then at 336 the last screen type may be determined. If the last screen type requires a sign-in (e.g., a shopping cart page), then the process may return to the home flow 314 in FIG. 3B. If the last screen type does not require a sign-in, then at 338 the last screen visited may be presented.

At 340, it may be determined if a daily delivery service, such as eBay now, is open. If so, the last screen visited 338 may continue. If not, then at 342 a store closed overlay may be placed over the last screen visited 338.

Also from the last screen visited 338, upon the third launch of the application, at 342 it may be determined if push notifications have been enabled. If so, then at 344 the application may be registered for push notifications. Otherwise, push notifications are not allowed.

If at 334 it was determined that a sign-in was saved, then at 348 the status of the cart and orders may be set in the app. At 350, it may be determined if the current location in the app is known. If so, then the process may proceed to the last screen visited 338. If not, it may proceed to the home flow 314.

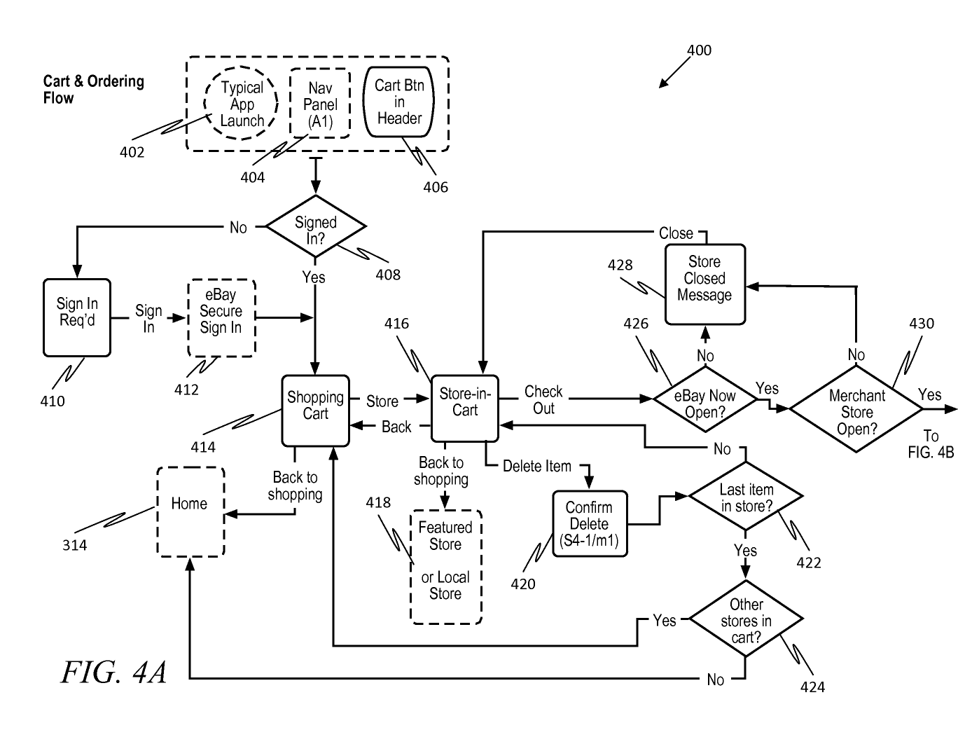

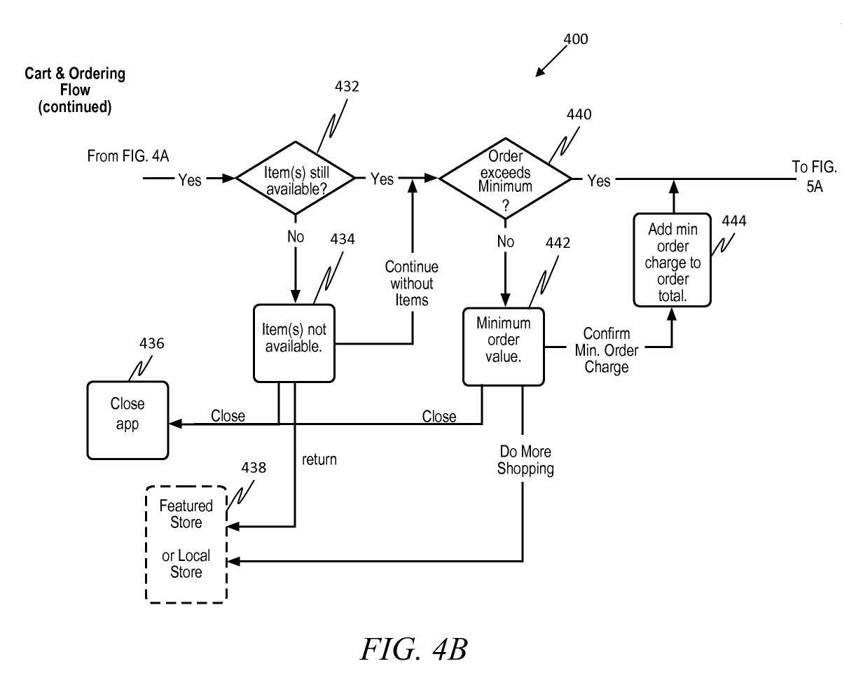

FIGS. 4A-4B are flow diagrams illustrating a method 400 of filling a shopping cart and ordering flow in accordance with an example embodiment. From either a typical application launch 402, a navigation panel 404, or a cart button in a header 406, the flow may proceed to 408, where it is determined if the user is signed in. If not, then a sign-in screen is presented at 410, and secure sign in is accomplished at 412. Once this is done, or if the user was already signed in, at 414 a shopping cart may be displayed.

From here, the user may return the home flow 314 if he or she wishes to shop more. Additionally, the cart can be directed to a particular shopping cart for a particular store, at 416. From there, the user can elect to go back to shopping, which may direct the user to the featured store (or a local store) at 418. The user could also delete an item in the shopping cart, which causes a screen confirming the deletion at 420. At 422, it may be determined if that is the last item in the cart from the store. If not, the flow may return to the store shopping cart at 416. If so, then at 424 it may be determined if there are other stores' items in the cart. If so, then the flow may return to the general shopping cart at 414. If not, the flow may return to the home flow 314.

The user could also check out from the store shopping cart, resulting in the system determining if the daily delivery service is open at 426. If not, then a store closed message can be displayed at 428. If so, then it may be determined if the merchant store whose items are in the cart is open at 430. If not, then the store closed message can be displayed at 428. If so, the flow may continue to 432 in FIG. 4B.

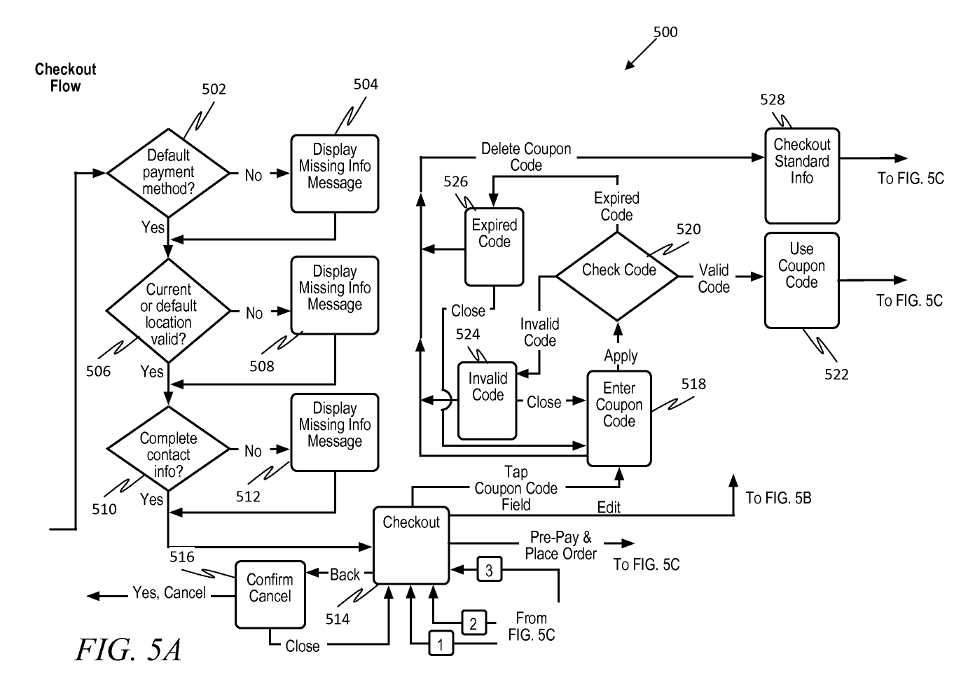

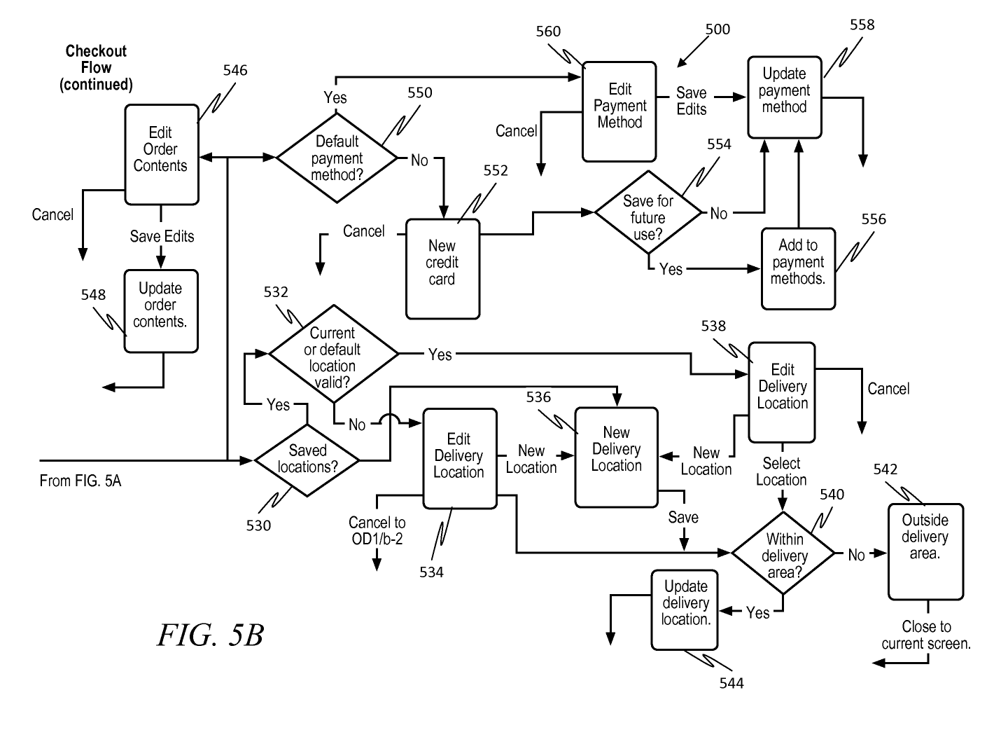

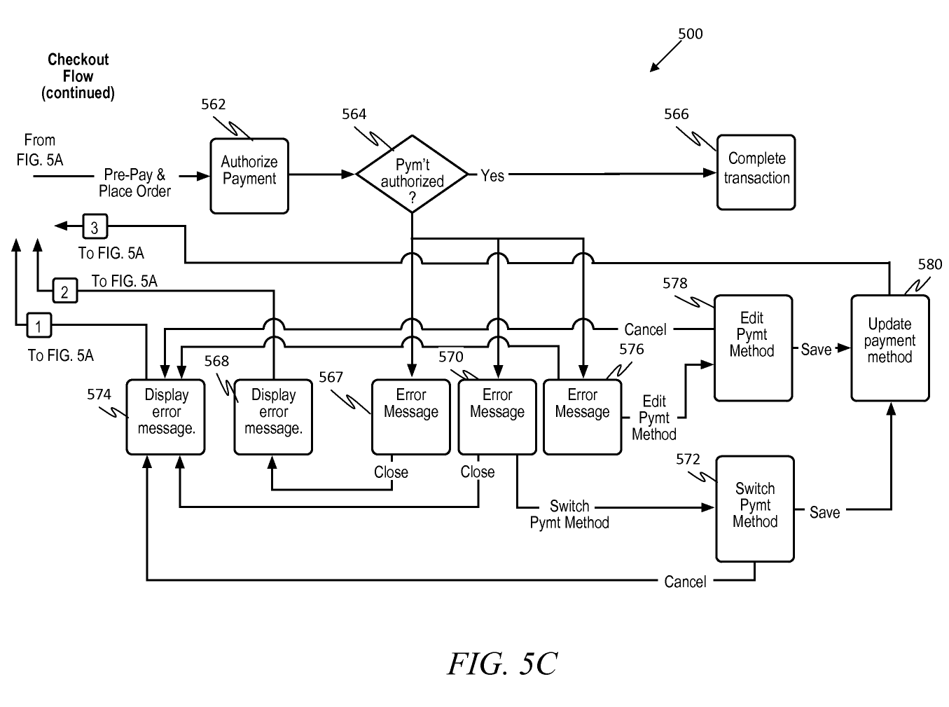

Turning to FIG. 4B, at 432, the system may determine if the item(s) ordered are still available. This may be accomplished by, for example, querying a real-time inventory database for the appropriate store(s). Alternatively the system may automatically place a phone call to the store to verify sufficient inventory. If the item(s) is/are not available, then the flow may proceed to 434, where a screen indicating that the item(s) is/are not available may be displayed to the user. This screen may allow the user to select from, for example, closing the application, returning to the featured store or local store (e.g, to purchase an alternative product), or continue checking out without the out-of-stock item(s). If the user chooses to close, then at 436 the application may be closed. If the user chooses to return to the store, then at 438 the system returns the flow to the store. If the user chooses to continue without the item(s), or if at 432 it was determined that the item(s) was/were available, then at 440 it may be determined if the order value exceeds a preset minimum (e.g., $25). If so, the flow proceeds to the checkout flow of FIG. 5A. If the order does not exceed the minimum, however, then at 442 a minimum order value screen is shown. Here the user is alerted to the fact that the order total falls below the minimum, and is given a choice to close the app (resulting in the flow proceeding to 436), do more shopping (resulting in the flow proceeding to 438), or add a minimum order charge to the order total at 444.

FIGS. 5A-5C are flow diagrams illustrating a method 500 of checking out in accordance with an example embodiment. At 502 is may be determined if the user has established a default payment method. If not, then at 504 a message may be displayed indicating that the default payment method is missing and prompting the user to enter it. At 506, it may be determined if the current location (or default location if the current location cannot be established) is valid. This may include, for example, determining whether the location is within a delivery area and is a valid address (e.g, can be found on a map). If the location is not valid, then at 508 a message may be displayed indicating that the location is not valid and prompting the user for a valid address. At 510, it may be determined if the complete contact information for the user is saved. If not, then at 512 a message may be displayed indicating that the contact information is incomplete and prompting the user for the missing information.

At 514, a checkout screen may be presented. This screen may provide the user with several choices, including to go back (e.g., cancel), tapping a coupon code field, pre-paying and placing the order, and editing some aspect of the order. If the user elects to go back, then at 516 he or she may be presented with a screen to confirm the cancel. If the user elects to tap a coupon code field, then at 518 the user may be prompted for entering the coupon code. Then, at 520 the code may be checked. If the code is valid, then the coupon code may be used at 522. If the code is invalid, then at 524 the user is presented with an invalid code message. If the code is expired, then at 526 the user is presented with an expired code message. In both cases, the coupon code is then deleted and standard checkout is performed at 528. If the user elected to pre-pay and place the order, then the flow may proceed to FIG. 5C. If the user elected to edit the order, then the flow may proceed to 530 of FIG. 5B.

Turning to FIG. 5B, at 530 is may be determined if there are any saved locations for the user. If so, then at 532 it may be determined if the current or default location is valid. If not, then at 534 the delivery location may be edited to form a new location 536. If the current or default location is valid, then at 538 the user may be provided with the ability to edit the delivery location, including selecting a new location (Resulting in flow to 536), cancelling, or selecting a saved location (resulting in flow to 540). At 540, it may be determined if the location is within the delivery area. If not, then a message saying as such can be displayed at 542. Otherwise, the delivery location may be updated at 544.

The user may also elect to edit the order contents, which may send the flow to 546 where the order contents are edited. Once they are saved (and not cancelled), the flow may proceed to 548, where the order contents may be updated.

The user may also elect to edit the default payment method, which may send the flow to 550, where the system may determine if there is a default payment method. If not, then at 552, the user may be prompted to add a new credit card, which they can enter or cancel. If the user enters the new credit card, then at 554 the user may be prompted to select whether to save the card for future use. If so, then the credit card can be added to the payment methods at 556 and a message indicating that the payment method has been updated can be displayed at 558. If there was a default payment method, at 560 the user may be prompted to edit the payment method.

Turning now to FIG. 5C, if the user elected to prepay and place the order, then at 562 the payment may be authorized. At 564, it may be determined if the payment is authorized. If so, then at 566 the transaction is completed. If not, then an error message may be displayed. What type of error message is displayed may depend on whether the lack of payment authorization is recoverable or not. If not, then at 567 a fatal error message is generated and then displayed at 568. If the lack of authorization can be recovered from by switching a payment method, then an error message may be generated at 570 and the user is provided with the opportunity to switch the payment method at 572 (or close and just display the error message at 574). If the lack of authorization can be recovered from by editing a payment method, then an error message may be generated at 576 and the user is provided with the opportunity to edit the payment method at 578. At 580, the payment method is updated.

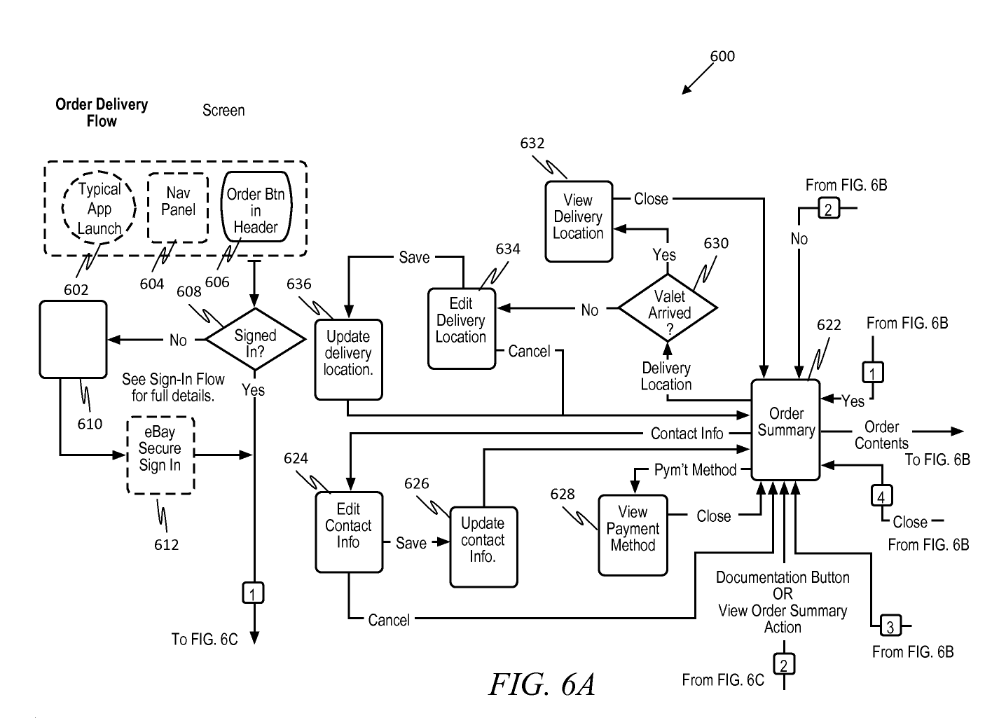

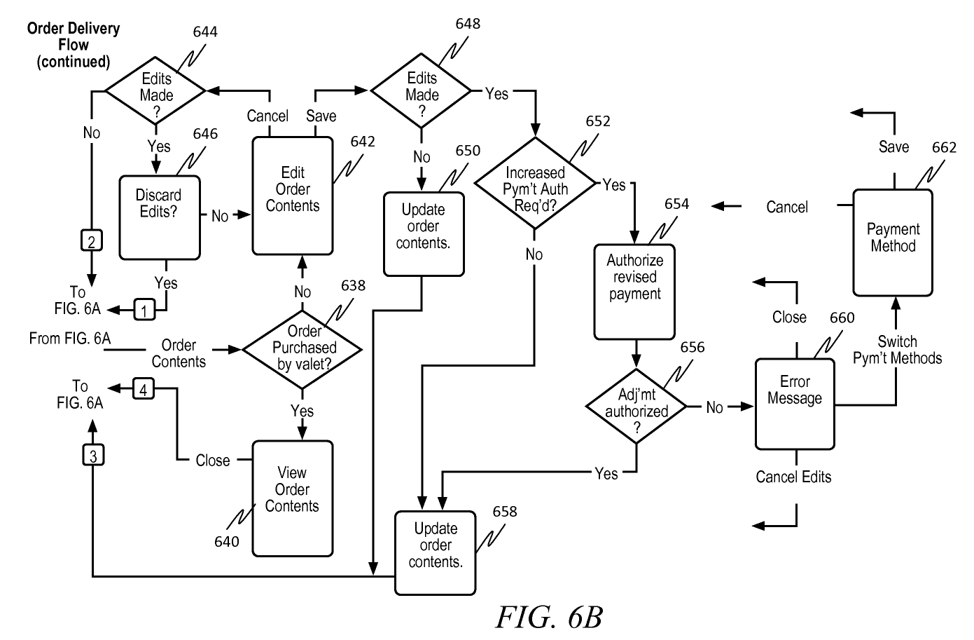

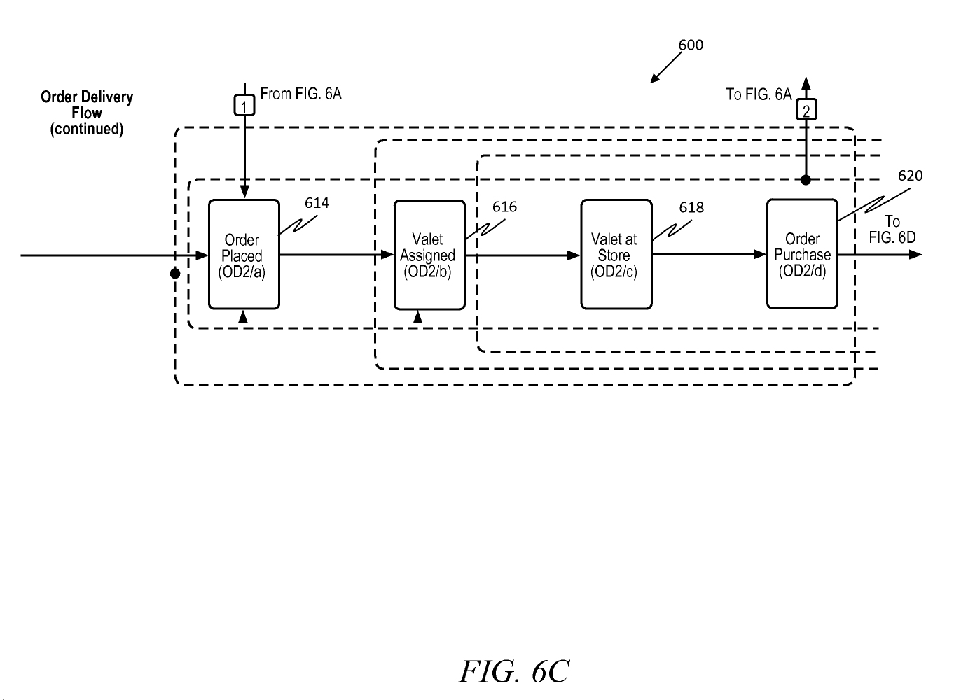

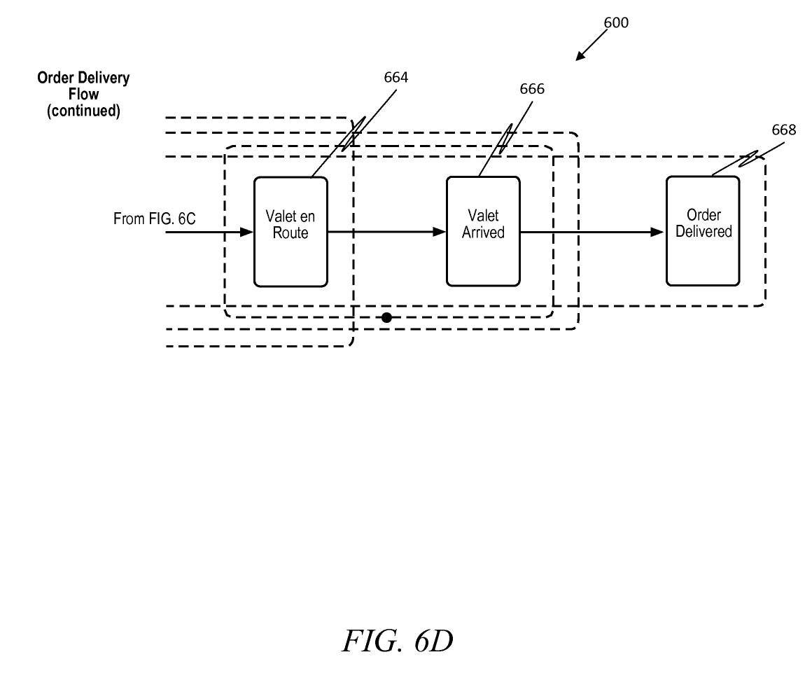

FIGS. 6A-6D are flow diagrams illustrating a method 600 of delivering an order in accordance with an example embodiment. From either a typical application launch 602, a navigation panel 604, or an order button in a header 606, the flow may proceed to 608, where it is determined if the user is signed in. If not, then a sign-in screen is presented at 610, and secure sign in is accomplished at 612. Once this is done, or if the user was already signed in, the process may proceed to FIG. 6C.

Turning to FIG. 6C, at 614 the order may be placed. Then, at 616, a valet may be assigned to the order. Then the valet may travel to the store and the flow may proceed to 618, where the user is notified that the valet is at the store. The valet may then complete the purchase at 620. From there, the flow may either return to FIG. 6A or proceed to FIG. 6D. Proceeding to FIG. 6A occurs so that the user can view current status of the order. Proceeding to FIG. 6D occurs so that the delivery can actually be accomplished. Beginning first with FIG. 6A, the flow may proceed to 622 where the user can view a summary of the order. From this screen, the user may chose a number of different paths, including editing the contact information (at 624, which then is saved at 626), viewing the payment method (at 628), and viewing the delivery location. Selecting to view the delivery location results in a determination of whether the valet has arrived at 630. If the valet has arrived, then the delivery location is viewed at 632. If not, the user can edit the delivery location at 634 and update it at 636.

The user can also indicate he or she wishes to edit the order contents, which may cause the flow to proceed to FIG. 6B. Specifically, at 638, it may be determined if the order has been purchased by the valet. If so, the user can view the order contents at 640. If not, then the user can edit the order contents at 642. While editing, the user may cancel, which may cause the flow to proceed to 644, where it is determined if any edits have been made so, and then those edits can be discarded at 646. The user can also save the edits, causing the flow to proceed to 648, where a decision is made as to whether or not edits have been made yet. If not, then the order contents may be updated at 650. If so, then at 652 it may be determined if an increased payment authorization is required (e.g., if the total cost for the order has increased). If so, then at 654 the revised payment may be authorized. A decision may be made at 656 as to whether the adjusted amount was authorized. If so, then the order contents may be updated at 658. If not, then an error message may be displayed at 660. At this point, the user can choose to close, cancel edits, or switch payment methods, the latter of which causes the flow to proceed to 662 for the new payment method.

Turning now to FIG. 6D, this flow is encountered from 620 of FIG. 6C. Specifically, at 664, the user may see that the valet is en route. At 666, the user may see that the valet has arrived. At 668, the user may receive confirmation that the order has been delivered.

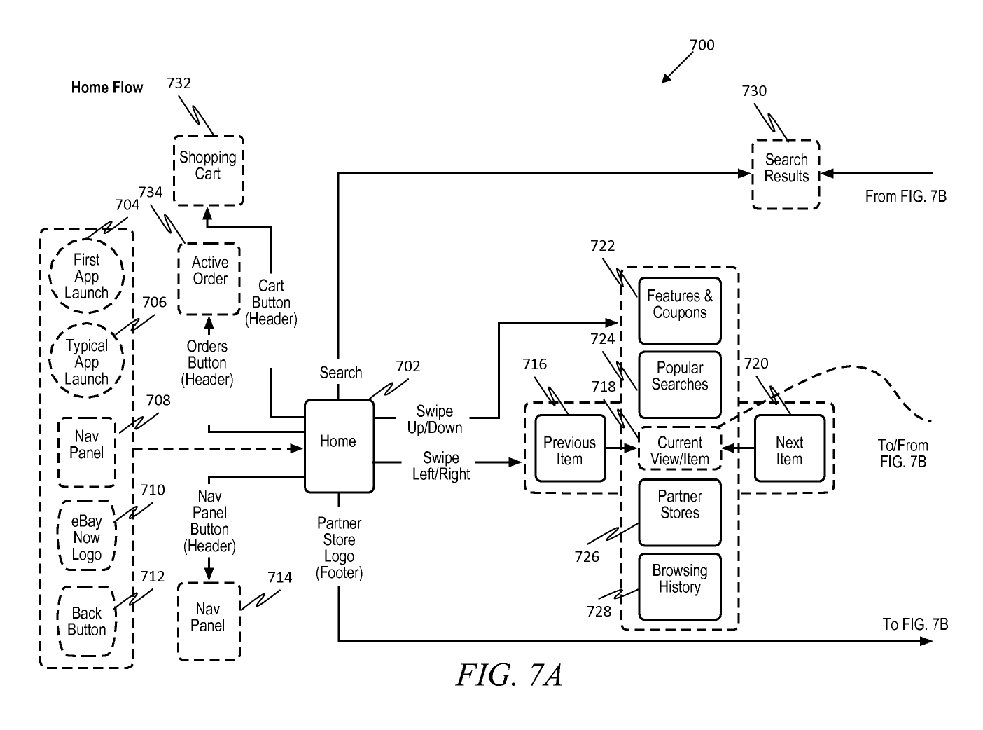

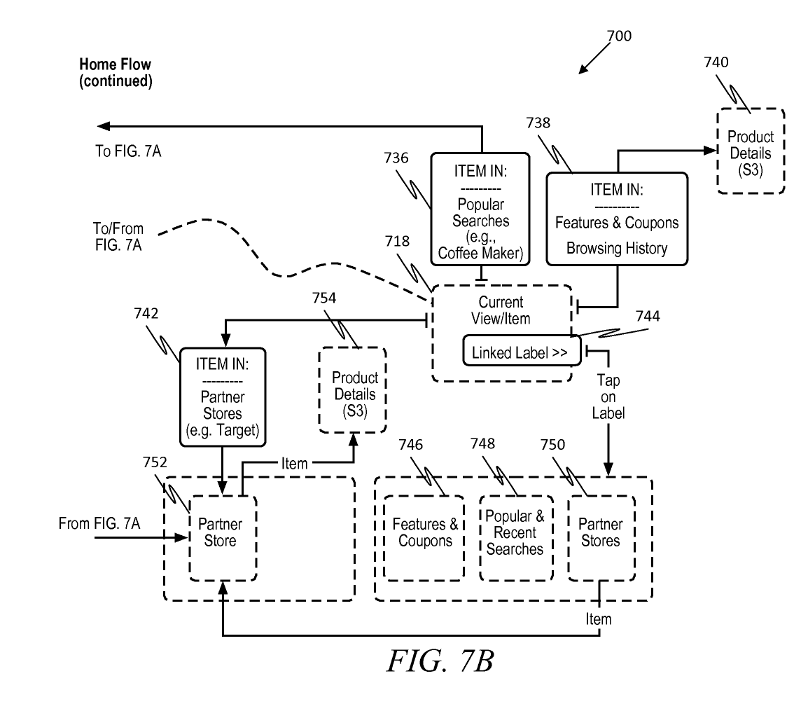

FIGS. 7A-7B are flow diagrams illustrating a method 700 of executing a home flow, such as home flow 314 of FIG. 3, in more detail, in accordance with an example embodiment. The home page 702 may be launched from a first application launch 704, a typical application launch 706, a navigation panel 708, a daily delivery service logo link 710, and a back button 712. From the home page 702, the user may select a navigation panel button, which launches the navigation panel 714. Alternatively, the user can select a partner store logo (such as in a footer), which may send the flow to FIG. 7B, which will be described later. Alternatively, the user can swipe left or right, which may allow the user to scroll between a previous item 716, a current view/item 718, and a next item 720. Alternatively, the user can swipe up or down, which may allow the user to scroll among features and coupons 722, popular searches 724, a current view/item 718, partner stores 726, and a browsing history 728.

Alternatively, the user may perform a search, which may result in search results 730 (obtained from FIG. 7B, described later). Alternatively, the user may select a cart button, which may bring up a shopping cart 732. Alternatively, the user can select an orders button, which may bring up an active order 734.

Turning now to FIG. 7B, when the user proceeds to the current view/item 718, the screen may be populated with popular searches 736, features and coupons 722 and browsing history 738 (with product details 740), partner stores 742, and a linked label 744. Tapping on the linked label 744 brings up screens showing features and coupons 746, popular and recent searches 748, and partner stores 750. Selecting an item from a partner store 750, as well as directly navigating to a partner store 750 from FIG. 7A, results in the partner store 752 being displayed, with perhaps additional product details 754 for a selected product.

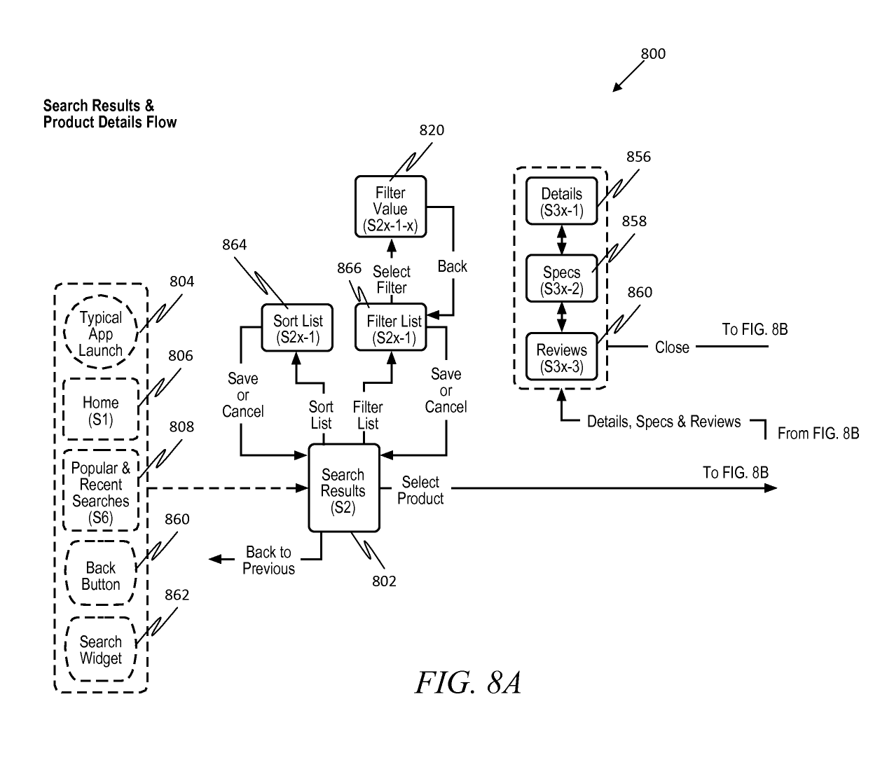

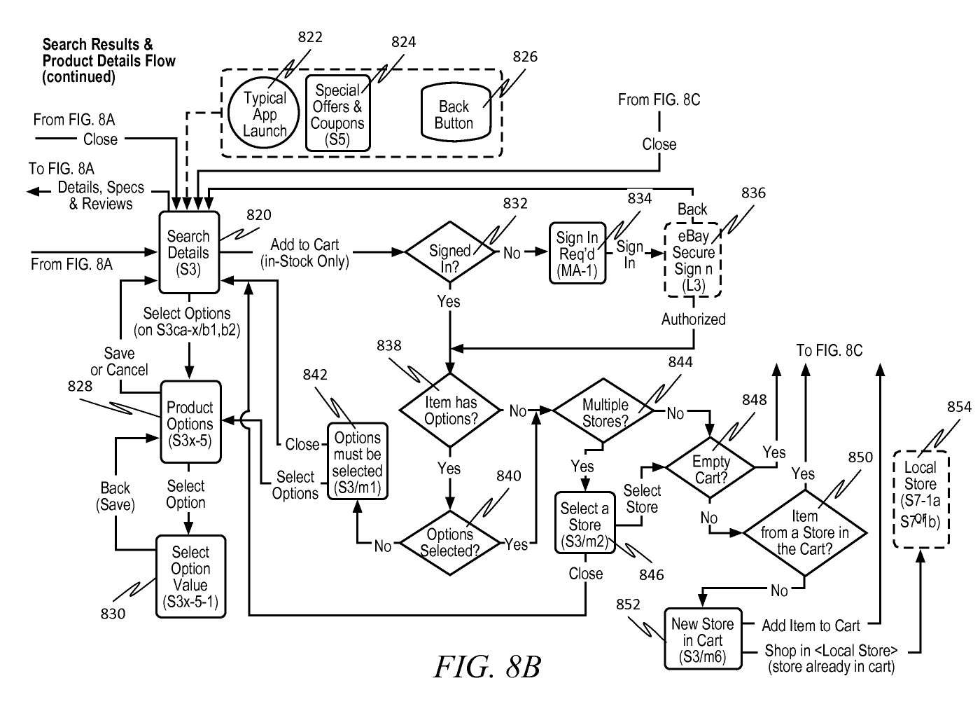

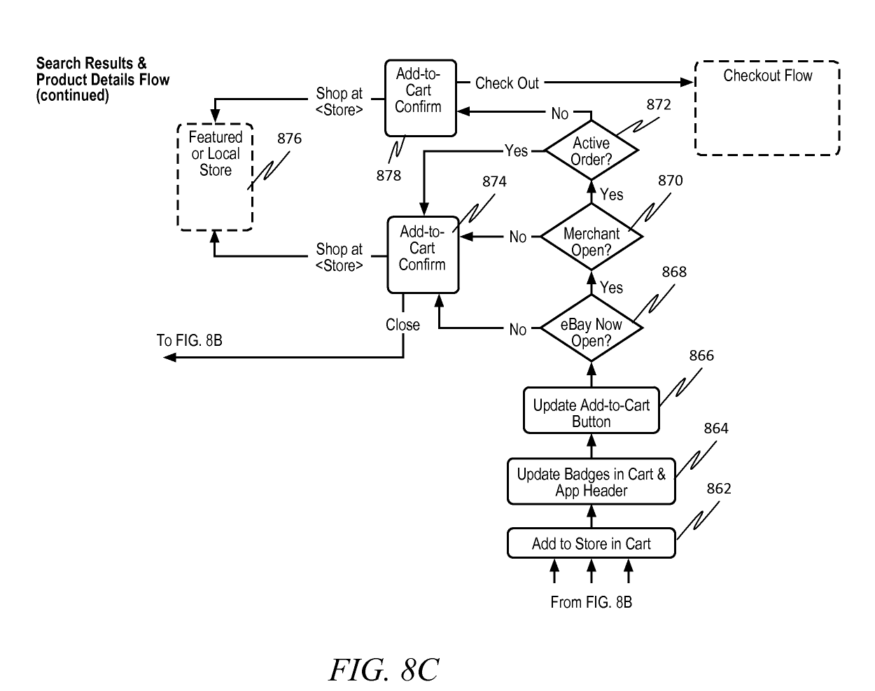

FIGS. 8A-8C are flow diagrams illustrating a method 800 of determining and presenting search results, such as search results 730 of FIG. 7, in more detail, in accordance with an example embodiment. Here, search results 802 may be accessed via a typical application launch 804, a home page 806, popular and recent searches 808, a back button 810, or a search widget 812. The search results 802 may be sorted using a sort list 814 or filtered using a filter list 816 having one or more filter values 820. A user may select a product (e.g., one of the search result) from the search results 802, which results in the flow progressing to search details 820 of FIG. 8B. The search details 820 can also be accessed directly from a typical application launch 822, special offers and coupons 824, or a back button 826.

The user can select product options from the search details 820, resulting in product options 828. The user can then select an option, resulting in a select option value page 830. These options may then be transmitted when the user selects to add to cart (for in stock items) from the search details 820. At that point, the system may determine whether the user is signed in at 832, and if not, inform the user that sign in is required at 834 and sign the user in at 836. Then, at 838, it may be determined whether the item has options. If so, then at 840 it may be determined if the options have been selected. If not, the options must be selected, which is communicated to the user at 842 and then the flow returns to the product options 828. If the user has already selected options, or if the item has no options, then at 844 it may be determined if there are multiple stores represented in the cart. If so, then at 846 one of the stores may be selected. At 848, it may be determined if the cart is empty. Assuming it is not, then at 850 it may be determined if there is an item from a store already in the cart. If not, then a new store may be added to the cart at 852. The user may then add the item to the cart, or alternatively elect to shop more in the local store (already in the cart) at 854.

The user may also elect to view details, specs, and reviews from the search details 820. This results in a return to FIG. 8A, and specifically the flow progresses to display details 856, specs 858, and/or reviews 860.

When an item is added to a cart, the flow proceeds to 862 of FIG. 8C, where the item is added to the store in the cart. Then at 864 badges are updated in the cart and application header. Then an add-to-cart button is updated at 866. Then it may be determined if the local delivery service is open (e.g., it is not after-hours) at 868. Assuming it is open, then at 870 it is determined if the merchant is open. If so, then at 872 it is determined if the order is active. If so, then at 874 the user in prompted to confirm the addition to the cart and is then sent to the featured or local store at 876. If the order is not active, then at 878 the user is prompted to confirm the addition to the cart and is then sent to the checkout flow described earlier in FIGS. 5A-5C.

The integration of couriers (also known as valets) into the system may be accomplished by providing a logistics API platform that monitors and distributes tasks to couriers. This may include, for example, determining delivery capacity as well as scheduling and delivery. A courier marketplace may be used to connect delivery people with deliveries. In some embodiments, a bidding system may be utilized to provide the ability for couriers to bid on deliveries. Given the limited timeframe for same-day deliveries, however, in some embodiments local couriers may join the marketplace and provide parameters as to what prices points and service level agreements they would be willing to agree to. The system could then dynamically allocate “winners” of such bidding processes as the couriers for various jobs.

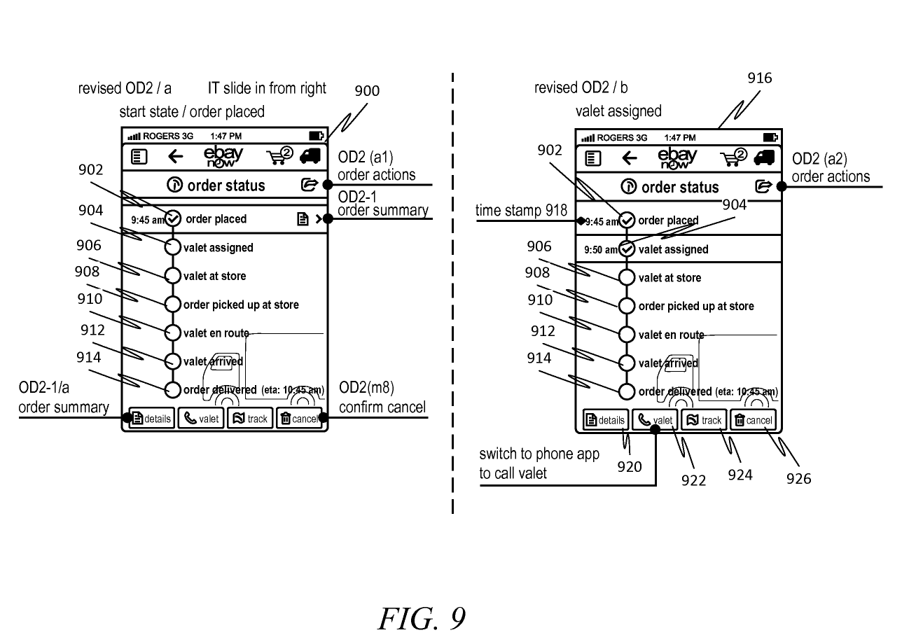

From the user perspective, the user may be presented with various screens when engaging in a transaction where a valet is assigned. Example screen captures are provided in FIGS. 9-16.

FIG. 9 depicts screen captures in accordance with an example embodiment. Screen capture 900 depicts an order status page, where a user can see an updated status of the delivery. Various check boxes, such as check boxes 902-914 may be provided to show the overall status. As can be seen, check box 902 is selected, indicating that the order has been placed. Screen capture 916 depicts a valet assigned page, where checkbox 904 has been selected. Each phase in the delivery process may also have an associated time stamp, such as time stamp 918.

Additional buttons 920-926 may be provided to allow the user to navigate to different screens, such as using button 920 to navigate to a details page, button 922 to navigate to a phone app to call the valet, button 924 to navigate to a tracking page, and button 926 to cancel the order.

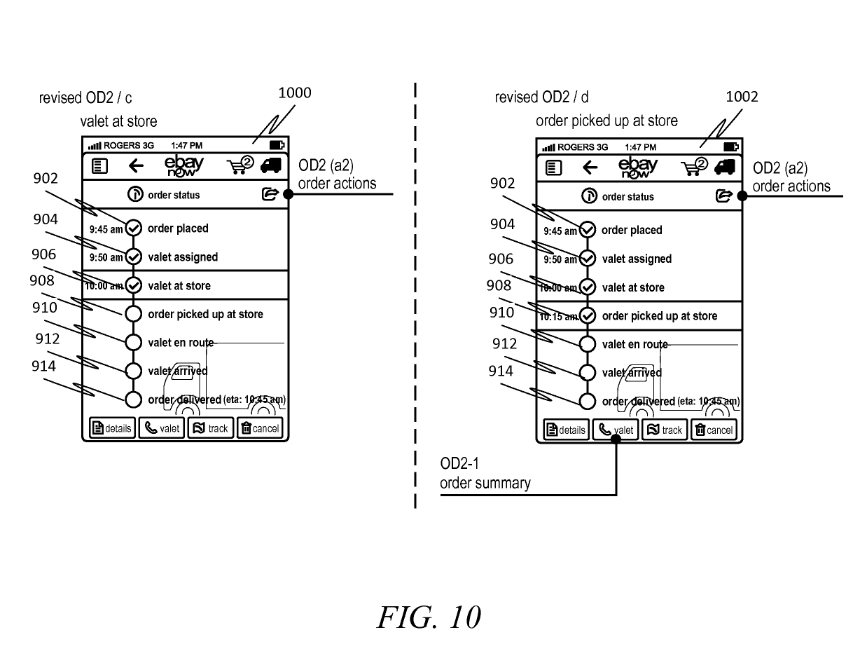

FIG. 10 depicts further screen captures in accordance with an example embodiment. Screen capture 1000 depicts the order status page when the valet is at the store. As can be seen, check box 906 has been checked. Screen capture 1002 depicts the order status page when the valet has picked up the order at the store. As can be seen, check box 908 has been checked.

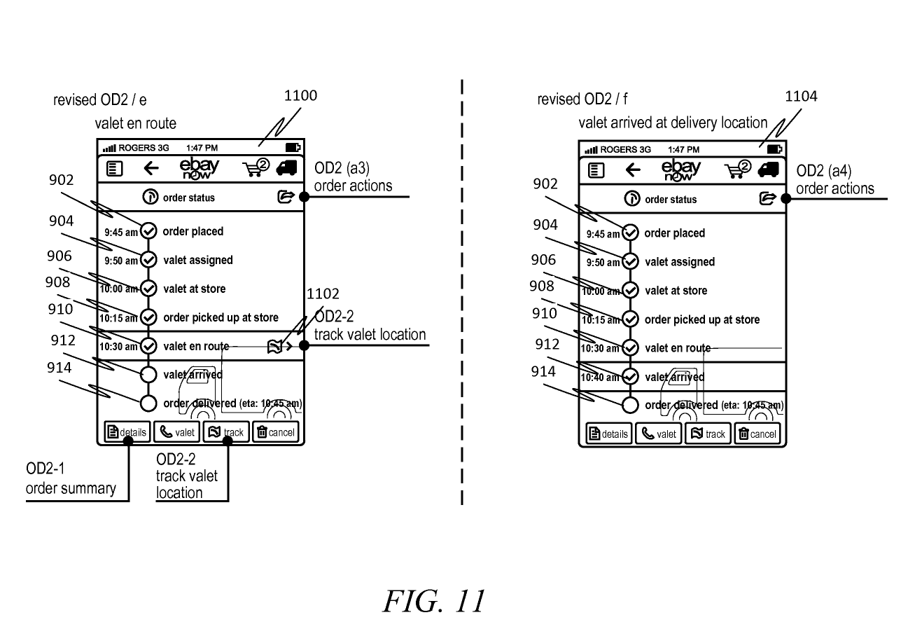

FIG. 11 depicts further screen captures in accordance with an example embodiment. Screen capture 1100 depicts the order status page when the valet is en route. Notably, a button 1102 appears that allows the user to depict the exact position of the valet, such as by using a GPS module in a mobile device of the valet and overlaying the location on a map. Check box 910 has been checked. Screen capture 1104 depicts the order status page when the valet has arrived at the delivery location. Check box 912 has been checked.

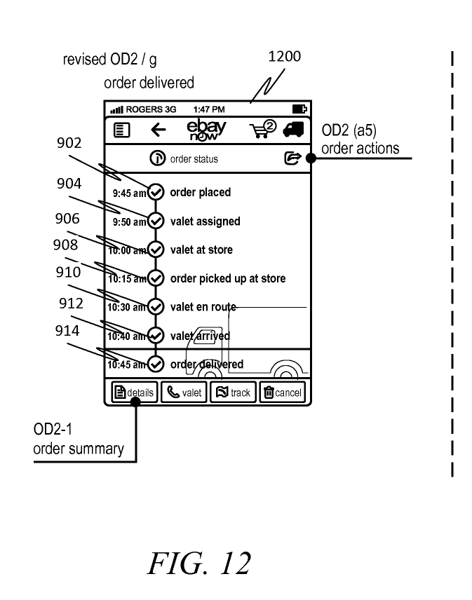

FIG. 12 depicts a further screen capture in accordance with an example embodiment. Screen capture 1200 depicts the order status page when the order has been delivered. Check box 914 has been checked.

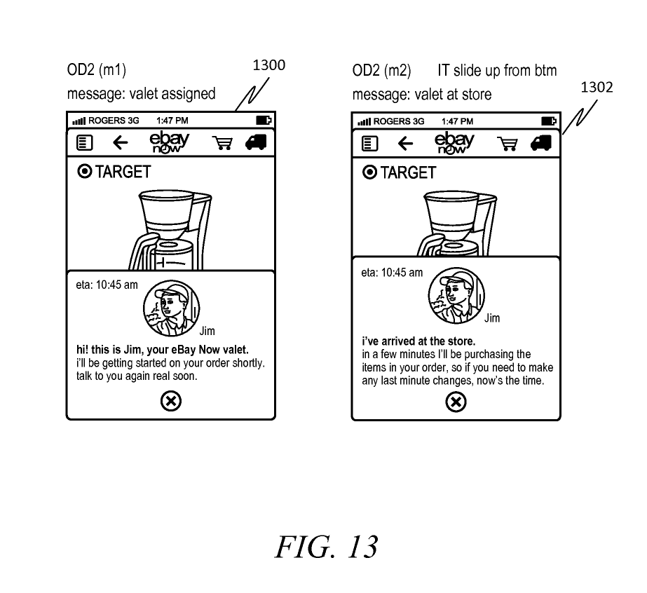

FIG. 13 depicts further screen captures in accordance with an example embodiment. Screen capture 1300 depicts a message sent to a user when a valet is assigned. Screen capture 1302 depicts a message sent to a user when a valet has arrived at the store.

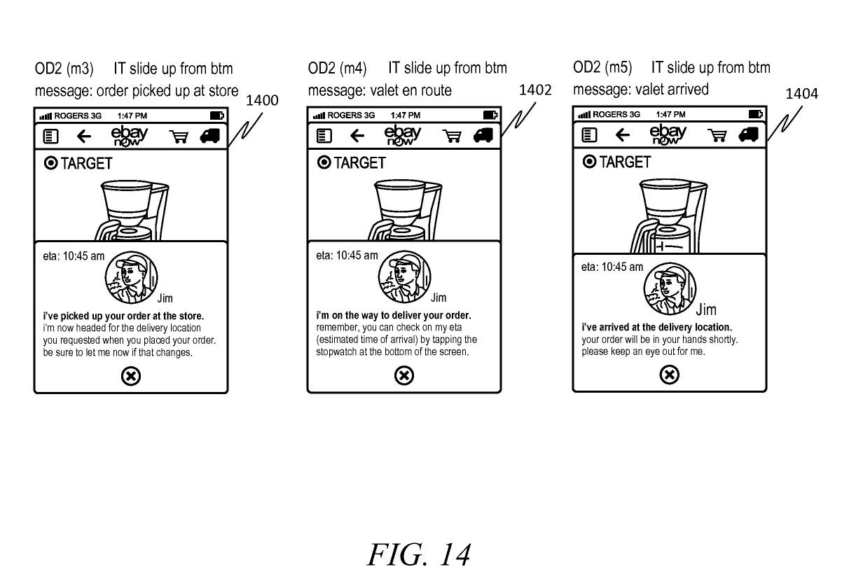

FIG. 14 depicts further screen captures in accordance with an example embodiment. Screen capture 1400 depicts a message sent to a user when the valet has picked up the order at the sore. Screen capture 1402 depicts a message sent to a user when the valet is en route to deliver the order. Screen capture 1404 depicts a message sent to a user when the valet has arrived at the delivery location.

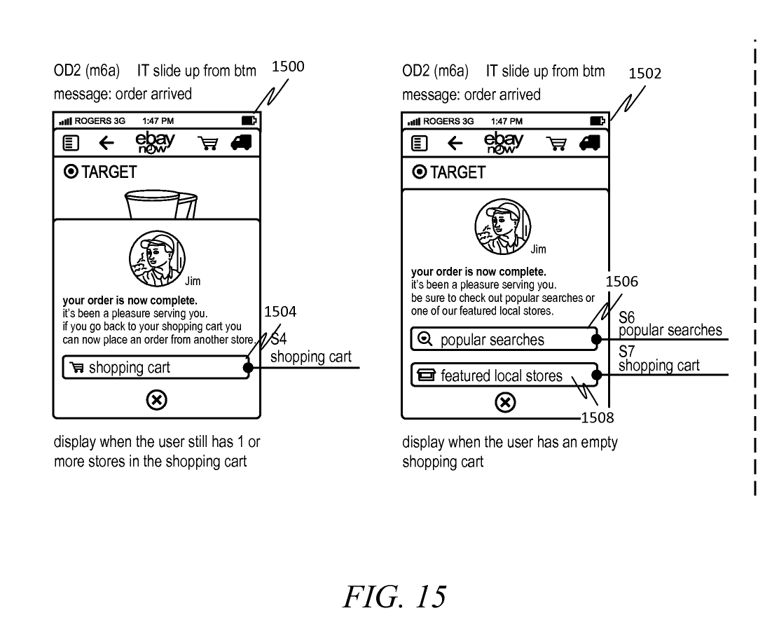

FIG. 15 depicts further screen captures in accordance with an example embodiment. Screen captures 1500 and 1502 depict a screen the user may navigate when the order is complete. The user may select to see their shopping cart 1504, popular searches 1506, or featured local stores 1508.

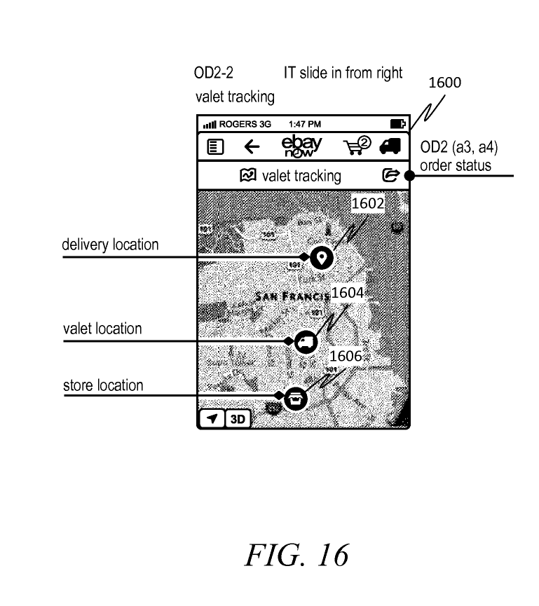

FIG. 16 depicts a further screen capture in accordance with an example embodiment. Screen capture 1600 depicts the delivery location 1602, valet location 1604, and store location 1606 on a map.

While the above embodiments may facilitate fulfillment and delivery from local retailers to a consumer, other embodiments may facilitate the fulfillment of purchases by other consumers or individuals. For example, a local electronics store may be able to sell a new television to a consumer, while a local user may be willing to sell a used version of the same television. The system may be configured to permit all types of sellers to fulfill purchases and obtain same-day delivery for their corresponding buyers.

In an example embodiment, location information for a consumer, obtained from a global positioning system (GPS) module or via a zip code provided in a profile, may be used to identify a store local to the user where an item can be purchased. Then a delivery person in the area can also be selected based on proximity to both the store and the consumer. This allows the system to provide same day, or even same-hour, delivery of an item directly to a user, wherever the user may be, and not merely deliver the product to the user's home like traditional delivery services. In another example embodiment, the delivery person is selected not just based on proximity but also based on one or more other factors, such as traffic, speed of route, time needed to check out at a particular store, etc. In short, time to execute may be utilized. The store can also be selected based on one or more of these factors. In some instances, for example, it may be faster for a courier to go to a store that is farther away due to these other variables.

Additionally, mechanisms may be utilized by a suitably configured system to handle cases where the user has moved locations since the product was ordered. In one example embodiment, the system may track when the user travels outside a particular radius and may notify the courier of this fact. This may allow the courier to update his or her travel plans, request that a different courier take over delivery for the item, or both. In another example embodiment, the user sends an updated location when the user arrives at a new location and desires that the item be delivered to the new location. In this manner, a button or other triggering mechanism may be provided on an application operated on a mobile device of the user. Such a button may be operable by the user to indicate that the system should use the user's current location, and not a previous location, as the delivery location 1602 for the item. This feature can also be used to differentiate between instances where the user is traveling to a different location temporarily but does not wish for the item to be delivered there, as well as instances where the user travels to a different location and wants the item delivered there. For example, a user may be at his workplace when an item is ordered, and delivery of the item may be arranged to occur at his workplace. Then, the system may detect that the user has left his workplace (e.g., by tracking the user's mobile device via global positioning system (GPS) data). If the system is configured to wait until the user indicates that a new location should be used as a delivery location 1602 (by, e.g., using the triggering mechanism), then the system may be configured to redirect the delivery to the user's home in certain circumstances (e.g., if the user travels home and activates the triggering mechanism). On the other hand, if the user was merely traveling to run some errands and is planning on returning to work shortly, the system wouldn't alter the previously arranged delivery to the user's workplace.

In another example embodiment, the system may attempt to anticipate a change in delivery location 1602 when it detects that the user has changed locations from when the item was purchased. Calendar information, contact lists, turn-by-turn directions, user profile information, or other suitable user information may be used to deduce whether or not the user is traveling to a location likely to be wanted as a delivery location 1602. For example, if the user is traveling on a route frequently taken to his workplace, or the user's calendar indicates a meeting is scheduled shortly after the item is purchased, the system may deduce that the user is heading to his workplace and may act to schedule the delivery location 1602 to be at that workplace, even though the user has not affirmatively indicated yet that his workplace is the desired delivery address. This may allow the system to anticipate a user's later actions, and more accurately and efficiently distribute the deliveries to the appropriate couriers. As an example, the user may order an item while at home, and then begin to travel to his workplace. The courier that would be selected if delivery to the user's home was appropriate might be different than the courier that would be selected if delivery to the user's workplace was appropriate. The system may determine the likelihood that the user may, in fact, want to redirect the delivery to his workplace, and if that likelihood is above a certain predetermined threshold value, assign the delivery to the courier that would be selected if delivery to the user's workplace was appropriate. The system may be configured to do this despite the fact that the user has not yet affirmatively indicated that he wishes for the item to be delivered to his workplace instead of his home.

In one example embodiment, user locations are tracked periodically in real time from the moment an order is placed to the moment the order is delivered (e.g., every millisecond, every second, every minute, or every 10 minutes). This may be accomplished by, for example, an application operating on the user's mobile device, in conjunction with GPS information from the user's mobile device. For example, the application may periodically query a GPS module on the mobile device for the user's current information, and this information may then be uploaded to the system (e.g., a server machine within the system) for real-time tracking of user location.

Delivery people may be equipped with mobile applications that allow the delivery people to log in and inform the system that they are on duty. At that point, a GPS module in each of their mobile devices can be used to track them. In one example embodiment, the system begins with a very accurate reading, but accuracy is reduced over time to help preserve battery life.

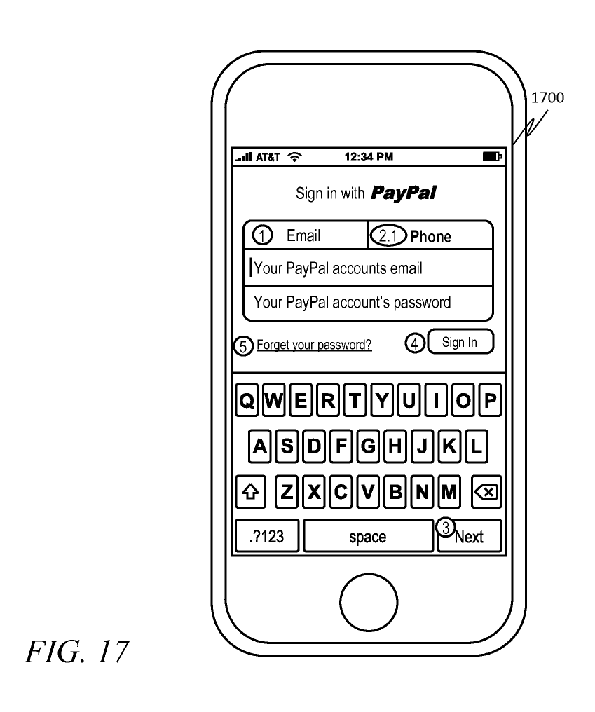

FIGS. 17-22 depict screen captures showing a mobile application available to delivery people in accordance with an example embodiment. FIG. 17 is a screen capture 1700 depicting a sign-in screen in accordance with an example embodiment. As can be seen, even though the user in this case is a valet, he or she may still sign in using a traditional sign in page for a payments service.

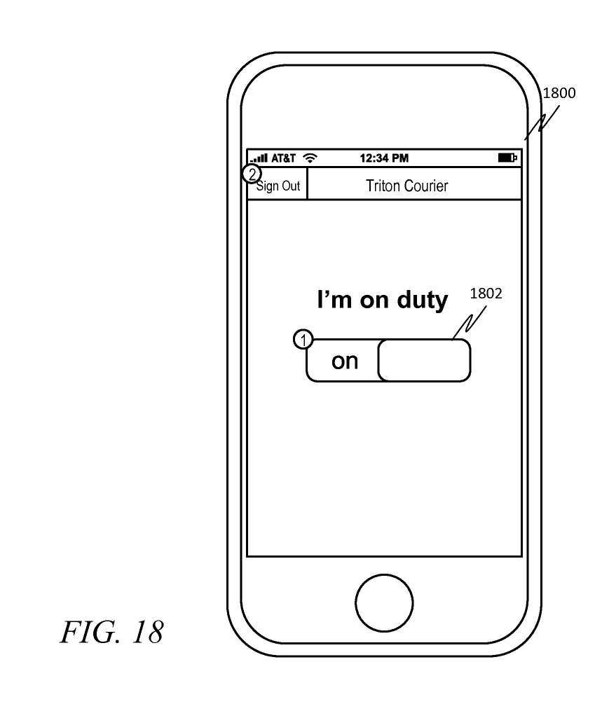

FIG. 18 is a screen capture 1800 depicting a screen where the valet may indicate he or she is on duty (or not). A slider 1802 may be provided to allow the valet to switch between the options. When a valet is off duty, in an example embodiment he or she will not be assigned to any orders. It should be noted that while this embodiment assumes the valet is either completely on duty or completely off duty, embodiments are foreseen where the valet has varying levels of availability. For example, the valet may indicate the valet is available for short trips, but not for longer ones, as he or she is going off duty soon.

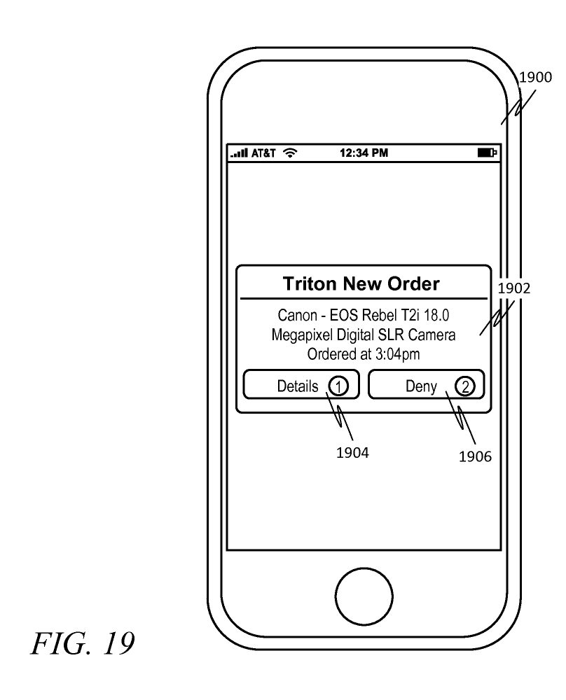

FIG. 19 is a screen capture 1900 depicting a screen where the valet may receive a new order. This may include a brief summary 1902 of the order, a details button 1904, and a deny button 1906. If the valet wishes to decline the job, then the valet may select the deny button 1906. Alternatively, the valet can select the details button 1904 to view additional information about the order.

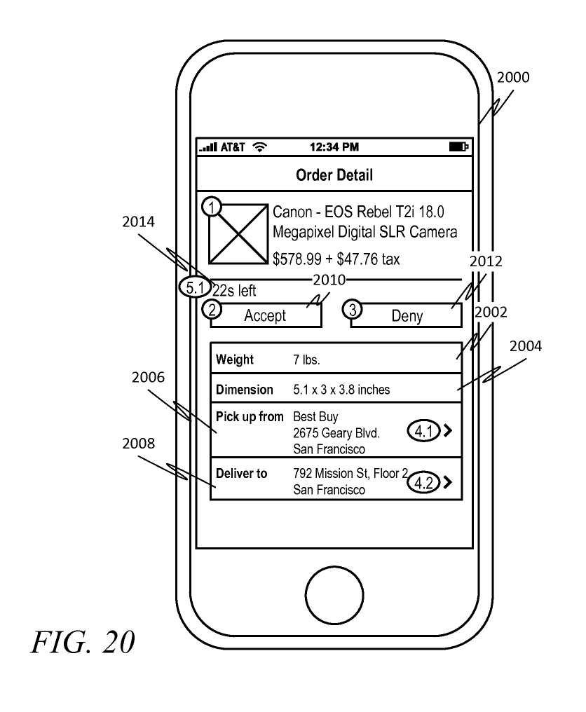

FIG. 20 is a screen capture 2000 depicting a screen where the valet may view additional order detail. This may include information like the weight 2002 and dimension 2004 of the order, as well as the pick up location 2006 and delivery location 2008. This screen may also provide an accept button 2010 where the valet can accept the order, as well as a deny button 2012 to turn down the job. The valet may also be presented with a time limit 2014 by which time the valet must make a decision.

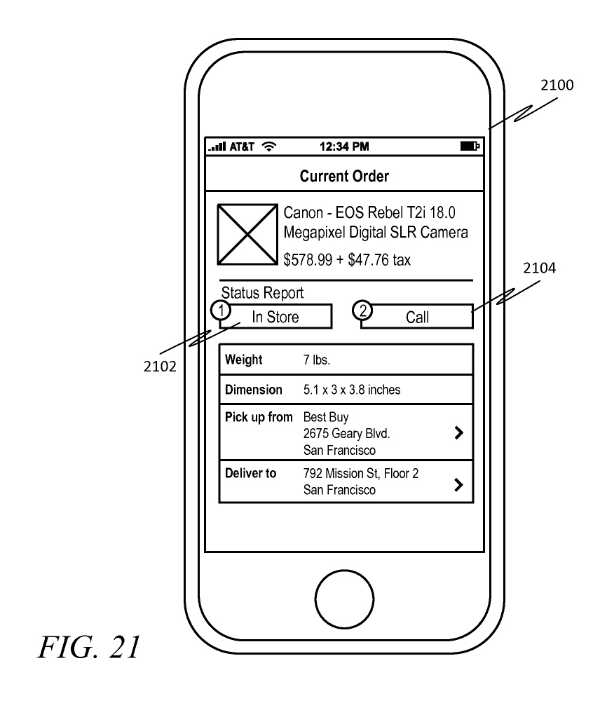

FIG. 21 is a screen capture 2100 depicting a screen once the valet has accepted the order. As can be seen, an in-store button 2102 is provided, which allows the valet to indicate when he or she is in the store. A call button 2104 may also be provided so the valet can phone the purchaser and inform them of an ETA or any delays, as well as ask questions in case the desired item is unavailable (e.g., is this other alternative item OK?).

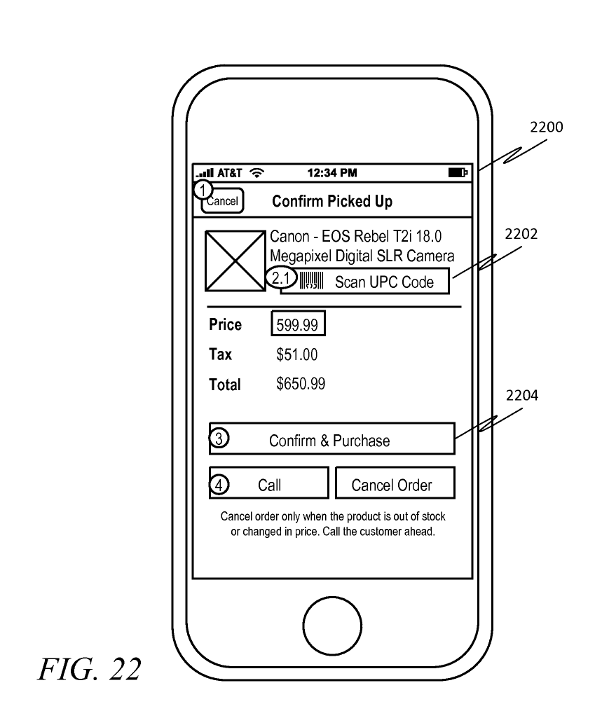

FIG. 22 is a screen capture 2200 depicting a screen that allows the valet to confirm that the item has been picked up. The valet may scan the UPC code of the item using button 2202, and may also confirm and purchase the item 2204. This embodiment may be depicting a case where the valet is able to check out from the store using their mobile device, bypassing a typical checkout line.

In another example embodiment, delivery jobs can be reassigned dynamically. For example, if one courier gets a flat tire, another courier may be assigned to pick the item up from the previous courier and complete the delivery. Additionally, multiple couriers may be assigned to a single job. For example, in areas where parking can be difficult, a bicycle courier may be dispatched to actually purchase the item, and then deliver it to another courier who may take it to the consumer by car.

Additionally, multiple jobs may be assigned to the same courier. If, for example, the courier is picking up items for one consumer at a particular store, that same courier can pick up items for another consumer at the same store.

In an example embodiment, pickers may be placed at commonly used stores. A picker is a person who is designated to stay in one particular store and simply purchase items on behalf of consumers, and pass those items on to couriers for delivery.

Couriers may be provided with dynamically fillable debit cards, which they can use to pay for the items. The system can dynamically add funds to the cards when the consumer initiates the purchase, thus enabling the card to have enough funds for the courier to make the purchase.

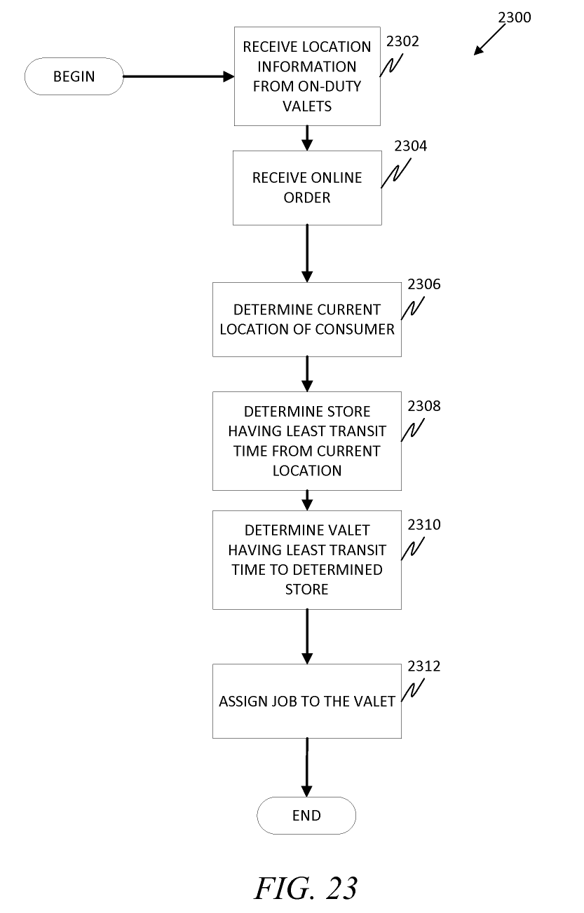

In another example embodiment, the courier can be securely associated with the transaction. The buyer may pay the store (e.g., through the system), but the courier is then enabled to pick up the item on behalf of the buyer. FIG. 23 is a flow diagram illustrating a method 2300 in accordance with an example embodiment. At operation 2302, location information may be received from a plurality of mobile devices operated by on-duty valets. At operation 2304, an online order for local delivery of an item to a consumer may be received. At operation 2306, a current location of the consumer may be determined. At operation 2308, a store having a least transit time from the current location of the consumer that has the item in stock is determined. At operation 2310, a valet having a least transit time to the determined store may be determined. At operation 2312, a job may be assigned to the valet having the least transit time to the determined store.

### Example Mobile Device

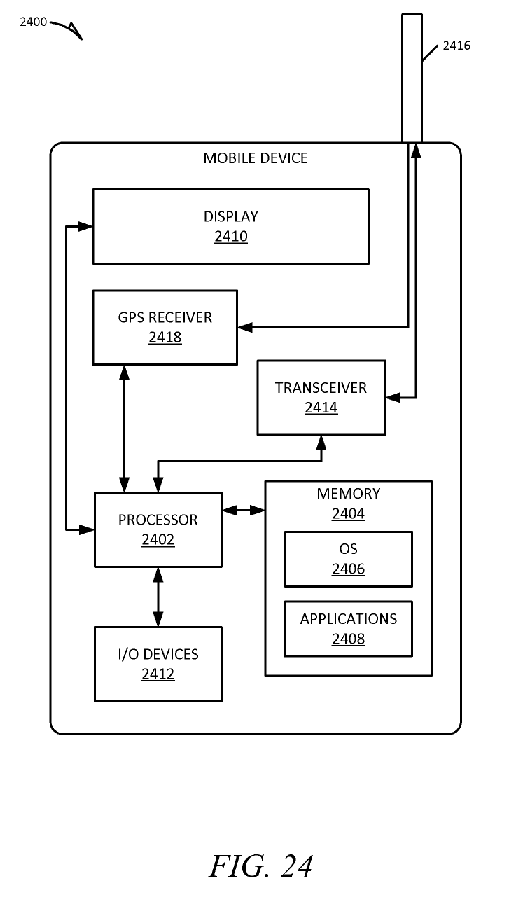

FIG. 24 is a block diagram illustrating a mobile device 2400, according to an example embodiment. The mobile device 2400 may include a processor 2402. The processor 2402 may be any of a variety of different types of commercially available processors 2402 suitable for mobile devices 2400 (for example, an XScale architecture microprocessor, a microprocessor without interlocked pipeline stages (MIPS) architecture processor, or another type of processor 2402). A memory 2404, such as a random access memory (RAM), a flash memory, or other type of memory, is typically accessible to the processor 2402. The memory 2404 may be adapted to store an operating system (OS) 2406, as well as application programs 2408, such as a mobile location enabled application that may provide LBSs to a user. The processor 2402 may be coupled, either directly or via appropriate intermediary hardware, to a display 2410 and to one or more input/output (I/O) devices 2412, such as a keypad, a touch panel sensor, a microphone, and the like. Similarly, in some embodiments, the processor 2402 may be coupled to a transceiver 2414 that interfaces with an antenna 2416. The transceiver 2414 may be configured to both transmit and receive cellular network signals, wireless data signals, or other types of signals via the antenna 2416, depending on the nature of the mobile device 2400. Further, in some configurations, a GPS receiver 2418 may also make use of the antenna 2416 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors 2402 may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure processor 2402, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors 2402 that are temporarily configured (e.g., by software) or permanently configured to perform the relevant operations. Whether temporarily or permanently configured, such processors 2402 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 2402 or processor-implemented modules. The performance of certain of the operations may be distributed among the one or more processors 2402, not only residing within a single machine, but deployed across a number of machines. In some example embodiments, the processor 2402 or processors 2402 may be located in a single location (e.g., within a home environment, an office environment or as a server farm), while in other embodiments the processors 2402 may be distributed across a number of locations.

The one or more processors 2402 may also operate to support performance of the relevant operations in a “cloud computing” environment or as a “software as a service” (SaaS). For example, at least some of the operations may be performed by a group of computers (as examples of machines including processors 2402), these operations being accessible via a network 104 (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 2402, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors 2402 executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 2402), or a combination of permanently and temporarily configured hardware may be a design choice. Below are set out hardware (e.g., machine) and software architectures that may be deployed, in various example embodiments.

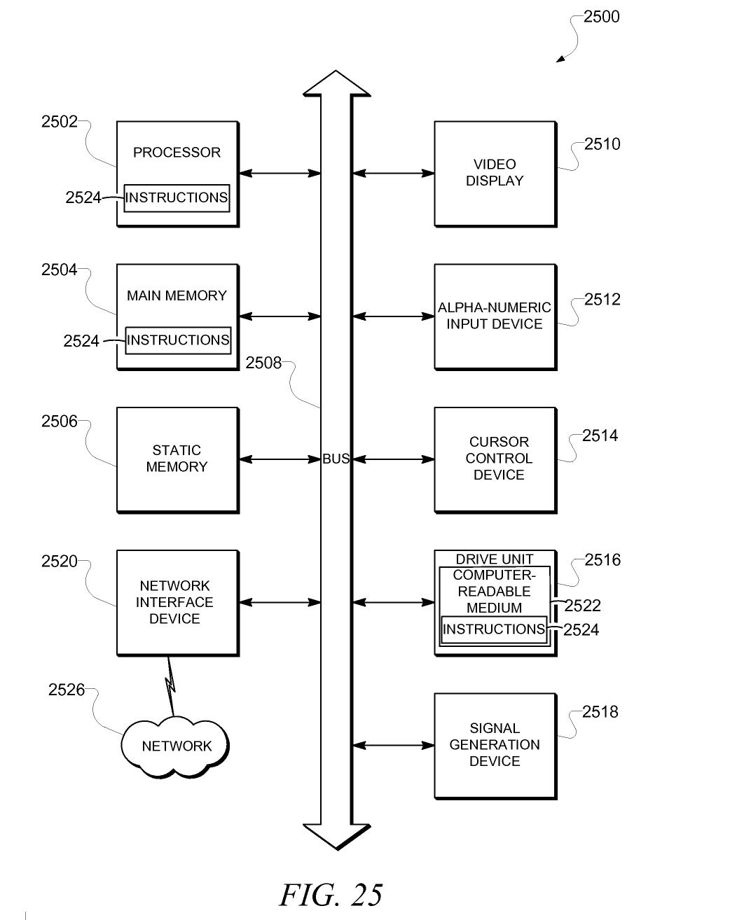

FIG. 25 is a block diagram of a machine in the form of a computer system within which a set of instructions may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In one embodiment, the machine will be a server computer; however, in alternative embodiments, the machine may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2500 includes a processor 2502 (e.g., a central processing unit (CPU), a graphics processing unit (GPU) or both), a main memory 2504 and a static memory 2506, which communicate with each other via a bus 2508. The computer system 2500 may further include a display unit 2510, an alphanumeric input device 2512 (e.g., a keyboard), and a user interface (UI) navigation (e.g., cursor control) device 2514 (e.g., a mouse). In one embodiment, the display, input device 2512 and cursor control device 2514 are a touch screen display. The computer system 2500 may additionally include a storage device (e.g., drive unit) 2516, a signal generation device 2518 (e.g., a speaker), a network interface device 2520, and one or more sensors (not pictured) such as a global positioning system sensor, compass, accelerometer, or other sensor.

The drive unit 2516 includes a machine-readable medium 2522 on which is stored one or more sets of data structures and instructions 2524 (e.g., software) embodying or utilized by any one or more of the methodologies or functions described herein. The instructions 2524 may also reside, completely or at least partially, within the main memory 2504 and/or within the processor 2502 during execution thereof by the computer system 2500, the main memory 2504 and the processor 2502 also constituting machine-readable media 2522.

While the machine-readable medium 2522 is illustrated in an example embodiment to be a single medium, the term “machine-readable medium” may include a single medium or multiple media (e.g., a centralized or distributed database, and/or associated caches and servers) that store the one or more instructions 2524. The term “machine-readable medium” shall also be taken to include any tangible medium that is capable of storing, encoding or carrying instructions 2524 for execution by the machine and that cause the machine to perform any one or more of the methodologies of the embodiments of the present invention, or that is capable of storing, encoding or carrying data structures utilized by or associated with such instructions 2524. The term “machine-readable medium” shall accordingly be taken to include, but not be limited to, solid-state memories, and optical and magnetic media. Specific examples of machine-readable media 2522 include non-volatile memory, including by way of example, semiconductor memory devices, e.g., EPROM, EEPROM, and flash memory devices; magnetic disks such as internal hard disks and removable disks; magneto-optical disks; and CD-ROM and DVD-ROM disks.

The instructions 2524 may further be transmitted or received over a communications network 2526 using a transmission medium via the network interface device 2520 utilizing any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., Wi-Fi® and WiMax® networks). The term “transmission medium” shall be taken to include any intangible medium that is capable of storing, encoding or carrying instructions 2524 for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A system comprising:
a purchase fulfillment system executable by a processor and configured to:
receive an online order for local delivery of an item to a consumer;
determine a current location of the consumer;
determine a store having a least transit time from the current location of the consumer that has the item in stock;
a delivery tracking system configured to:
receive location information from a plurality of mobile devices operated by on-duty valets;
determine an on-duty valet having a least transit time to the determined store; and
assign a job to the on-duty valet having the least transit time to the determined store.

2. The system of claim 1, wherein the online order is received from a mobile device of the consumer.

3. The system of claim 1, wherein the purchase fulfillment system is further configured to receive a new location of the consumer and the delivery tracking system is further configured to reassign the job to another valet to complete delivery of the item to the new location.

4. The system of claim 3, wherein the reassigning includes coordinating a pass off between an original valet assigned to the job at the original location of the consumer and the other valet assigned to the job at the new location of the consumer, when the original valet has already picked up the item.

5. The system of claim 1, wherein the delivery tracking system is further configured to assign the job to another valet who will coordinate with the original valet to team up to deliver the item.

6. The system of claim 5, wherein the original valet uses a bicycle to pick up the item from the determined store and the other valet uses a motorized vehicle to deliver the item to the consumer.

7. The method of claim 5, wherein the original valet is a picker stationed at the determined store.

8. A method comprising:
receiving location information from a plurality of mobile devices operated by on-duty valets;
receiving an online order for local delivery of an item to a consumer;
determining a current location of the consumer;
determining a store having a least transit time from the current location of the consumer that has the item in stock;
determining a valet having a least transit time to the determined store; and
assigning a job to the valet having the least transit time to the determined store.

9. The method of claim 8, wherein the online order is received from a mobile device of the consumer.

10. The method of claim 9, further comprising receiving a new location of the consumer and reassigning the job to another valet to complete delivery of the item to the new location.

11. The method of claim 10, wherein the reassigning includes coordinating a pass off between an original valet assigned to the job at the original location of the consumer and the another valet assigned to the job at the new location of the consumer, when the original valet has already picked up the item.

12. The method of claim 8, further comprising assigning the job to another valet who will coordinate with the original valet to team up to deliver the item.

13. The method of claim 12, wherein the original valet uses a bicycle to pick up the item from the determined store and the other valet uses a motorized vehicle to deliver the item to the consumer.

14. The method of claim 12, wherein the original valet is a picker stationed at the determined store.

15. A non-transitory machine-readable storage medium having embodied thereon instructions executable by one or more machines to perform operations comprising:
receiving location information from a plurality of mobile devices operated by on-duty valets;
receiving an online order for local delivery of an item to a consumer;
determining a current location of the consumer;
determining a store that has the item in stock having a least transit time from the current location of the consumer;
determining a valet having a least transit time to the determined store; and
assigning a job to the valet having the least transit time to the determined store.

16. The non-transitory machine-readable storage medium of claim 15, wherein the online order is received from a mobile device of the consumer.

17. The non-transitory machine-readable storage medium of claim 16, further comprising receiving a new location of the consumer and reassigning the job to another valet to complete delivery of the item to the new location.

18. The non-transitory machine-readable storage medium of claim 17, wherein the reassigning includes coordinating a pass off between an original valet assigned to the job at the original location of the consumer and the another valet assigned to the job at the new location of the consumer, when the original valet has already picked up the item.

19. The non-transitory machine-readable storage medium of claim 15, further comprising assigning the job to another valet who will coordinate with the original valet to team up to deliver the item.

20. The non-transitory machine-readable storage medium of claim 19, wherein the original valet uses a bicycle to pick up the item from the determined store and the other valet uses a motorized vehicle to deliver the item to the consumer.
